(19) United States
(12) Patent Application Publication
(10) Pub. No.: US 2016/0210357 A1
(43) Pub. Date: Jul. 21, 2016

(54) AGGREGATING NEWS AND SOCIAL CONTENT WITH MAP PRESENTATIONS

(71) Applicant: Sean Wohltman, Falls Church, VA (US)

(72) Inventor: Sean Wohltman, Falls Church, VA (US)

(21) Appl. No.: 13/023,501

(22) Filed: Feb. 8, 2011

(51) Int. Cl. G06F 17/30

(52) U.S. Cl. CPC G06F 17/30864; G06F 17/30061; G06F 17/3053; G06F 17/30241

(57) ABSTRACT

Methods, systems, and apparatus, including computer programs encoded on a computer storage medium, for aggregating news and social content with map presentations. A method includes receiving map coordinates coinciding with a user viewport defining a region of map data. Map data corresponding to the region defined by the user viewport is obtained. A location corresponding to the region defined by the user viewport is identified, and a query corresponding to the identified location is generated. One or more collections of dated resources are searched using the generated query to obtain one or more resources that refer to the identified location, wherein the dated resources are news resources or social content resources. The dated resources are ranked based at least on the date of each resource. The map data is presented with one or more of the obtained dated resources according to the rank for each resource.

### BACKGROUND

This specification relates to providing information relevant to user queries.

Search systems provide access to vast amounts of data from a variety of resource collections, particularly when provided in a networked environment, e.g., the Internet. Some search systems also provide an interactive mapping system. Users can submit a query to the interactive mapping system to search for map entities, e.g., cities, states, countries, addresses, business names, etc. In response to a query, the interactive mapping system can display a geographic region.

### SUMMARY

This specification describes technologies relating to identifying news and social content search results and presenting geographic entities referenced in the search results in an interface of an interactive mapping system. Users seeking information about a particular geographic location are presented with aggregated news and social content updates about that geographic location. The news and social content updates can be automatically updated to present the user a current view of activity in or about that geographic location.

In general, one innovative aspect of the subject matter described in this specification can be embodied in methods that include the actions of receiving map coordinates coinciding with a user viewport, wherein the user viewport defines a region of map data; obtaining map data corresponding to the region defined by the user viewport; identifying a location corresponding to the region defined by the user viewport; generating a query corresponding to the identified location; searching one or more collections of dated resources using the generated query to obtain one or more resources that refer to the identified location, wherein the dated resources are news resources or social content resources; ranking the dated resources based at least on the date of each resource; and presenting the map data with one or more of the obtained dated resources according to the rank for each resource. Other embodiments of this aspect include corresponding systems, apparatus, and computer programs, configured to perform the actions of the methods, encoded on computer storage devices.

These and other embodiments can each optionally include one or more of the following features. The dated resources are one or more news resources and one or more social content resources. Generating the query includes using a database of geographic entity names to identify a geographic entity name associated with a location corresponding to the query. The ranked list of dated resources is updated, including searching updated additions to the one or more collections and providing the map data with the updated list.

Another innovative aspect of the subject matter described in this specification can be embodied in methods that include the actions of receiving a query; searching one or more collections of dated resources using the query to obtain one or more resources responsive to the query, wherein the dated resources are news resources or social content resources; ranking the dated resources based at least on the date of each resource; generating a list of the one or more dated resources according to the rank for each resource; identifying geographic entity names in the one or more obtained dated resources; identifying a geographic region corresponding to each identified geographic entity name; generating map data to differentiate the identified geographic regions from geographic regions that were not identified; and providing the map data with the list. Other embodiments of this aspect include corresponding systems, apparatus, and computer programs, configured to perform the actions of the methods, encoded on computer storage devices.

These and other embodiments can each optionally include one or more of the following features. The identified geographic regions are differentiated with location markers. The identified geographic regions are differentiated with different colors. The identified geographic regions are differentiated with different fill patterns. The dated resources are one or more news resources and one or more social content resources. The identified geographic region corresponds to a region defined by a user viewport. The query is translated into a second query before searching the one or more collections of dated resources. Translating the query into a second query includes using a database of geographic entity names to identify a geographic entity name associated with a location corresponding to the query. The ranked list of dated resources is updated, including searching updated additions to the one or more collections and providing the map data with the updated list.

Particular embodiments of the subject matter described in this specification can be implemented so as to realize one or more of the following advantages. Aggregating news and social content updates with an interactive mapping system provides users a convenient, up-to-date view of activity in a geographic location. The system provides users an interface for serendipitous discovery of events in a geographic area. The locations of current events can easily be identified, as well as other events happening at those locations. The level of activity in a location can be experienced by the amplitude of news and social content about a location, all by merely browsing to that location. Users can conveniently gauge the popularity of businesses and events at any current time of day in a geographic location.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an illustration of an example interface of a search system that provides an interactive mapping system with aggregated news and social content updates.

FIG. 2 is an illustration of an example search system for providing an interactive mapping system with aggregated news and social content.

FIG. 3 is a flow chart of an example process to generate map results with aggregated news and social content results.

FIG. 4 is an illustration of an example interface of a search system that provides an interactive mapping system with aggregated news and social content updates.

FIG. 5 is a flow chart of an example process to generate map results with aggregated news and social content results.

FIG. 6 is an illustration of an example interface of a search system that provides an interactive mapping system with aggregated news and social content updates.

Like reference numbers and designations in the various drawings indicate like elements.

### DETAILED DESCRIPTION

Search systems provide access to many kinds of resource collections. Some search systems provide access to map resources in an interactive mapping system.

In an interactive mapping system, client devices can request map data coinciding with a region of interest. Map data can include map images (e.g., political or topographic map images), satellite images, business locations, popular landmarks, driving or walking directions, and vector graphics defining paths and regions overlaid on map images. Map data can also include various layers of related data, for example, a layer illustrating volcanoes in the Pacific Ocean or current traffic conditions. The region of interest can be defined by a user viewport, which can be an element of the interactive mapping system interface. The user viewport can have different shapes, e.g., rectangular or square, and can show map data of a particular geographic region. In response to the request for map data, service providers can send the client device map data, which may be in the form of an image. The client's web browser then displays the map data or image in the user's viewport. Client devices can request map data by submitting queries. Interactive mapping systems can receive queries and provide map data responsive to received queries. Queries may correspond to various types of geographic entities, e.g., cities or countries. Queries may also correspond to specific locations (e.g., an address) or a specific entity (e.g., “baseball stadium”).

Additional resources provided by search systems, may include, for example, news resources and social content resources. Each resource can independently provide multiple pieces of information responsive to a query. These independent pieces of information can be located, combined, and presented in an interface including the interactive mapping system.

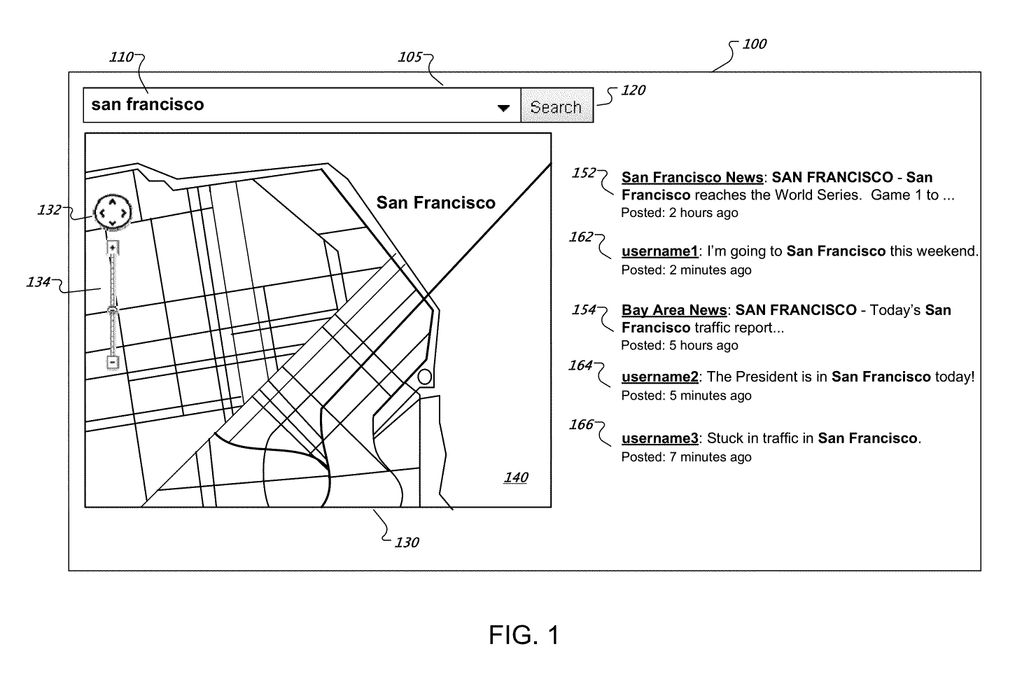

FIG. 1 is an illustration of an example interface 100 of a search system that provides an interactive mapping system with aggregated news and social content updates. Users of the search system can search for map data by submitting queries. In response to received queries, an interactive mapping system provides map data in the form of an image. The mapping interface 100 shown in FIG. 1 depicts a user viewport 130 centered on downtown San Francisco, Calif.

A user can enter a query 110 into a query box 105. By clicking a search button 120, the interactive mapping system can retrieve map data 140 and present the map data 140 in a viewport 130. The viewport 130 defines a range of current map coordinates to be displayed on the client device.

Queries can also be generated according to a location indicated by the center of the viewport 130. The latitude and longitude of the center of the viewport 130 can be used to look up a nearby map entity, e.g., an address, a business, a city, a county, a state, a country, etc. In some implementations, a database stores the latitude and longitude of each map entity along with a corresponding address of the entity. The latitude and longitude of the center of the viewport 130 can thus be used to generate one or more map entities at that latitude and longitude. In some implementations, the latitude and longitude of the center of the viewport 130 are translated into the nearest city. For example, query 110 could be generated by translating the latitude and longitude of the center of the viewport 130 into the nearest city, San Francisco, Calif.

To control what is shown in the user viewport 130, the interactive mapping system can include one or more interface elements, e.g., a panning control 132, a zoom control 134, a tilt control (not shown), or a rotation control (not shown). In some implementations, the user specifies a pan command by using an input device, e.g., a mouse, to drag the map image 140 or to manipulate the panning control 132. In some other implementations, the user specifies a pan command by dragging a finger across the screen of a touchscreen device. The interactive mapping system can provide data at multiple zoom levels (e.g., in response to a user input to the zoom control 130). Each subsequent zoom level provides more detail corresponding to a smaller geographic region.

In addition to the map data 140, the interface 100 presents a number of news search results (e.g., news search results 152 and 154) and social content search results (e.g., social content search results 162, 164, and 166) in response to a query (e.g., query 110). The date that the news and social content search results were posted can also be displayed with each result.

Each of the news search results 152 and 154 were retrieved in response to the query 110. In some implementations, the news search results are obtained from a search engine that searches multiple collections of news resources.

Each of the social content search results 162, 164, and 166 were retrieved in response to the query 110. In some implementations, the social content search results are obtained by searching updates of multiple social content providers. A social content provider is a service that allows users who are members of the social content provider to interact with other members, for example, by contributing and receiving content from other members. A social content provider can be a social networking site. Member content can include, for example, a status message, a microblog message, multimedia content, shared content originating from another source, or any other kind of content. A member can provide content publicly or to only one or more other specific members. In some implementations, social content is intended for a specific member or a specific subset of members of a social content provider. For example, a member may be associated with specific other members by connections established in the social content provider (e.g., as designated by the member). The member can choose to contribute content intended for or directed to one or more of those associated members. Content intended for one or more members may be publicly accessible. Publicly accessible social content responsive to the query 110 can be retrieved by a search engine and presented in the interface 100. In some implementations, the search system may provide an option for users of social content providers to opt-in or opt-out of making their social content accessible by users of the interface 100.

Using the query 110 input into an interactive mapping system to automatically retrieve news and social content updates allows users to view activity in a particular geographic location or region. For example, a user who submits query 110 (or has the query 110 automatically generated by the location of user viewport 130) can obtain an overview of current activity in San Francisco, Calif. From news search result 152, the user can learn that the San Francisco baseball team has made the baseball championship series, the World Series.

From social content result 162, a user can learn that “username1” is going to be in San Francisco this weekend. In some implementations, the interface 100 can display only those social content updates from users that are contacts with the user for the same social content provider. In this example, the user would be presented with a relevant update from “username1” only if they were contacts in a social content provider.

From news search result 154, the user can access a news story about traffic in San Francisco. By clicking on news search result 154, the user can be taken to the full news story shown in the news search result 154. From social content result 164, the user can see that “username2” has indicated that the President will be in San Francisco today. From social content result 166, the user can see that “username3” is stuck in traffic in San Francisco. In this way, the user can quickly obtain information about a particular geographic location shown in the viewport 130 of the interactive mapping system.

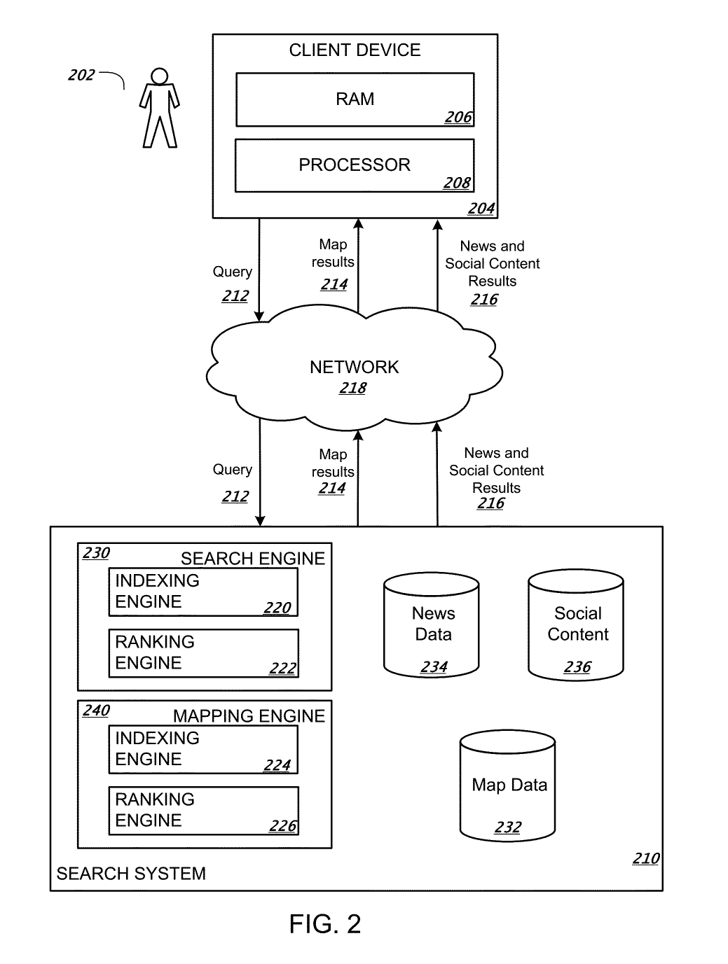

FIG. 2 is an illustration of an example search system 210 for providing an interactive mapping system with aggregated news and social content. The example search system 210 can provide search results relevant to submitted queries from multiple collections of resources. The search system can be implemented in an Internet, an intranet, or another client and server environment. The search system 210 is an example of an information retrieval system in which the systems, components, and techniques described can be implemented.

A user 202 can interact with the search system 210 through a user device 204. For example, the user device 204 can be a computer coupled to the search and mapping system 210 through a local area network (LAN) or wide area network (WAN), e.g., the Internet. The user device 204 will generally include a random access memory (RAM) 206 and a processor 208.

A user 202 can submit a query 212 to the search system 210. The query 212 can be in the form of a text string, or alternatively, as described above, the query 212 can be in the form of coordinates defined by a user viewport of an interactive mapping system. The query 212 can be sent to a search engine 230 within the search system 210 and to a mapping engine 240 within the search system 210. The search engine 230 and mapping engine 240 can be part of the same or different search systems. When the user 202 submits a query 212, the query 212 is transmitted through a network 218 to the search system 210. The search system 210 can be implemented as, for example, computer programs running on one or more computers in one or more locations that are coupled to each other through a network 218.

When the query 212 is received by the mapping engine 240, the mapping engine 240 identifies map results 214 that correspond to the query 212. Map results can be retrieved from a collection of map data 232. The map data 232 can be stored in various data structures on multiple storage subsystems. An indexing engine 224 can index the names of map entities contained in the collection of map data 232. The indexing engine can also store the latitude/longitude locations and addresses for map entities in the collection of map data 232. Indexing location information allows the system to translate a latitude and longitude point (e.g., as provided by a user viewport) into an address or an entity name. Additionally, an address can be translated into a latitude longitude point or an entity name.

The mapping engine 240 responds to the query 212 by generating map results 214, which are transmitted through the network 218 to the client device 204 in a form that can be presented to the user 202 (e.g., as an interactive mapping system web page to be displayed in a web browser running on the client device 204).

A query 212 received by the mapping engine 240 can also passed on to the search engine 230 or multiple other search engines. In the case of a text query, the query 212 can be passed on to the search engine 230 in its original form. In the case of a latitude and longitude query identified by a user viewport, the latitude and longitude can be translated into an entity name by the indexing engine 224 of the mapping engine. The entity name can then be passed on to the search engine 230 as a text query.

When the query 212 is received by the search engine 230 (either as the original text string or as an entity name translated from a latitude and longitude), the search engine 230 identifies resources that match the query 212. The search engine 230 can access resources stored in multiple collections, e.g., a collection of news data 234 and a collection of social content 236. The search engine 230 will generally include an indexing engine 220 that crawls and indexes resources (e.g., books, web pages, social content, images, or news articles stored as addressable resources accessible over the Internet) found in a collection or repository of content, an index (not shown) that stores the index information in one or more indices, and a ranking engine 222 (or other software) to rank the resources that match the query 210. The indexing and ranking of the resources can be performed using conventional techniques. The search system 210 can transmit results that are responsive to the query 212 as map results 214 and as news and social content results 216 through the network 218 to the user device 204 for presentation to the user 202. The map results 214 and news and social content results 216 can be presented to the user in an interface, for example, the interface 100 as shown in FIG. 1.

A query 212 received by the search engine 230 can also be passed on to the mapping engine 240. The query 212 can be passed on to the mapping engine 240 to be translated into a latitude and longitude by the indexing engine 224. The indexing engine can use the query 212 as an entity name and can look up a latitude and longitude or an address for the geographic entity name corresponding to the query 212. The latitude and longitude or address can be used by the mapping engine 240 to provide map results 214 indicating the locations of entities identified by the query 212.

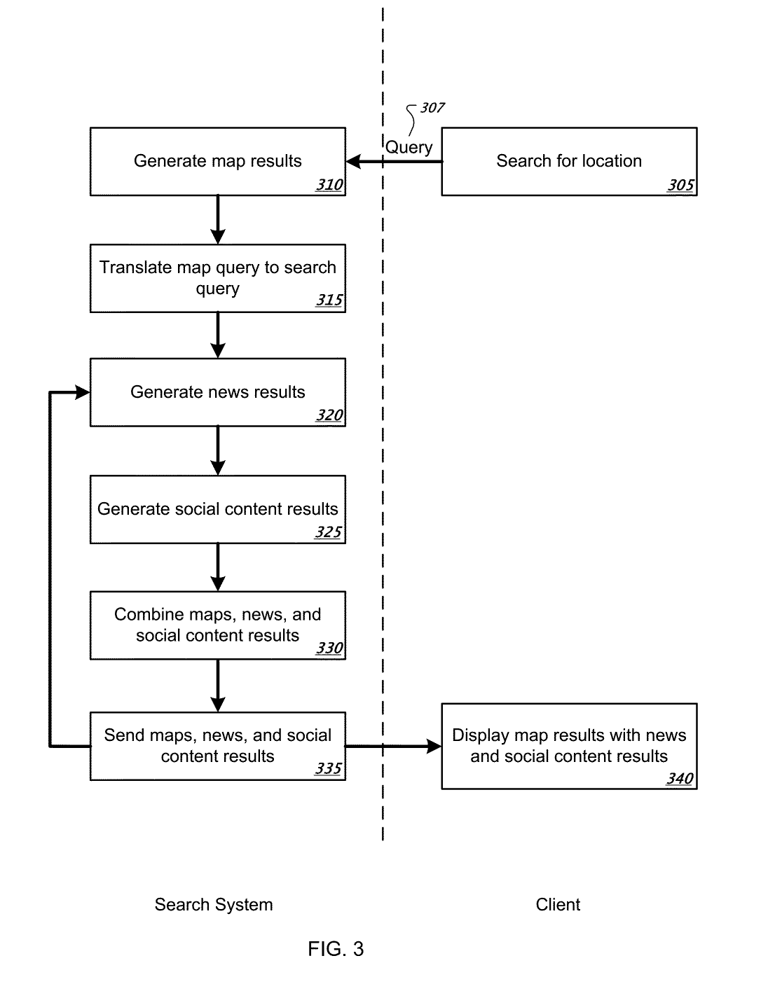

FIG. 3 is a flow chart of an example process to generate map results with aggregated news and social content results. In general, a search system obtains information about a location and uses the location name to search news and social content resources. The search system can then combine the map results, news results, and social content results into an interface, e.g., the interface 100 as shown in FIG. 1.

The process begins when a search for a location is initiated (305). The search for a location can be initiated either as a result of a user entering a query into a search box of an interactive mapping system, or as a result of the user navigating with the user viewport to a location of the interactive mapping system. When the search is initiated, by a user on a client device, for example, the query 307 is delivered to the search system. The query 307 can be identified as a query for which map results and aggregated news and social content results should be retrieved, for example, when the user selects an interface to submit the query, or when the user includes a predefined keyword in the query.

The search system receives the query 307 and generates map results responsive to the query (310). Map results can include any of the various types of map data responsive to the query, e.g., a map image or a satellite image. In some implementations, a marker is shown on the location identified by the query (in the case of a text query). In some implementations, if multiple locations match the query (e.g., “Springfield”), the search system selects the most popular location and provides other matching locations as alternatives. The search system typically centers the viewport on the location identified by the query. In the case of multiple matching locations, the system can center the viewport on the most popular location.

The search system translates the map query into a search query (315). If necessary, the search system translates the query used for the interactive mapping system into a search query that can be used to search news or social content resource collections. If, for example, the query 307 was a latitude and longitude as specified by a user viewport, the search system can identify a geographic entity name from the latitude and longitude to use as a search query. Multiple geographic entity names are possible for a geographic location, e.g., an address, a business name, a sports arena, a city, a county, a state, or a country. For example, if a user centers the user viewport at 37.8 degrees north and 122.4 degrees west, the search system can use a database to identify geographic entities near those coordinates. For 37.8 degrees north and 122.4 degrees west, the search system can identify the address 1301 Battery St. (address), Fog City Diner (business name), San Francisco Stadium (sports area), San Francisco (city), San Francisco (county), California (state), and United States of America (country). In some implementations, the query chosen depends on the zoom level of the interactive mapping system. For example, if the interactive mapping system is zoomed in to street level, the search system can choose an address or business name. In contrast, if the interactive mapping system is zoomed all the way out, the search system can choose the city, state, or country name for the search query.

The translation of the query may be unnecessary if the user submitted a text query to the interactive mapping system by, for example, typing the query into query box 105. However, a submitted text query may still undergo modifications to improve search results retrieved in later steps. For example, extra information may be dropped from the query. If a user submits a query for “San Francisco, Calif.,” the search system may drop the “CA” and identify only “San Francisco” as the search query for later steps. Alternatively, the query can be modified by expanding or contracting the query to well-known, popular, or colloquial variations. For example, the search system can recognize that a user query for “LA” is a popular form for the city “Los Angeles,” and can therefore expand the query into “Los Angeles” instead of another query (e.g. Louisiana) for which “LA” is less popular. In some implementations, the search system uses both queries or multiple other variations of a query when searching collections of resources.

The search system generates news search results (320). Using the identified search query, the search system can retrieve news results from one or multiple collections of news resources. The news resources can be ranked by relevance to the query as well as date posted, with newer articles given a higher ranking than older articles. The search system may also give more weight to a news resource that has the search query in the title or dateline of the news resource. For example, news result 152 as shown in FIG. 1 has the query “San Francisco” in the news story dateline.

The search system generates social content search results (325). The search system can use the identified search query to search publicly available updates from multiple social content services. Similar to news results, the social content search results can be ranked by both relevance and date posted. For example, social content result 162 of FIG. 1 can be ranked higher than social content result 164 because it was posted more recently. In some implementations, if the user is logged in to a current social content service, the search system can retrieve social content updates from the user's contacts, which might be unavailable to another user. The search system can generate social content results before generating news results or vice versa, or the search system can generate the results in parallel. Alternatively, the search system can generate only news results or only social content results. In some implementations, the search system retrieves both news and social content resources from the same collection.

The search system combines the maps, news, and social content search results (330). The search system can select a subset of the news and social content search results to be presented to the user. In some implementations, the search system selects a specified number of the highest-ranked news and social content results. In some other implementations, the search system arranges the news and social content search results together in a single ranking. In some implementations, the search system normalizes the results before assembling the final ranking so that no particular type of search result dominates or overwhelms results presented in the interface.

The search system sends the maps, news, and social content results to the client device (335). The search system can send these results over a communication network, e.g., the network 218 shown in FIG. 2. In some implementations, the search system automatically and periodically updates the news and social content search results and retransmits them to the client device (branch to 320).

The client device displays the map results with the news and social content results (340). The combined results can be displayed in a single interface, e.g., the interface 100 as shown in FIG. 1.

With the process as described in FIG. 3, the user can be presented with a continually and automatically updating stream of news and social content about a geographic location without ever typing a search query. Furthermore, the search query 307 can be updated each time the user browses to a new geographic location in the user viewport, resulting in continually updated news and social content about each new geographic location.

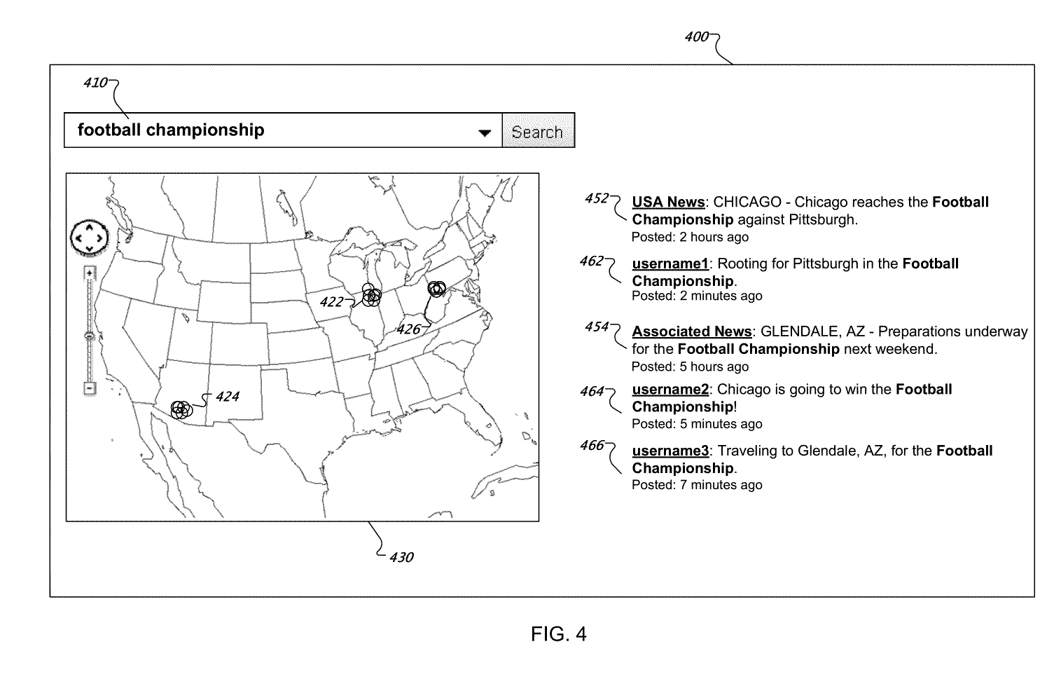

FIG. 4 is an illustration of an example interface 400 of a search system that provides an interactive mapping system with aggregated news and social content updates. The interface in FIG. 4 presents geographic locations identified in news and social content search results as data points in the interactive mapping system. Combining multiple data points in the viewport 430 can provide a “heat map” of the activity relating to a given query.

The query 410 entered into the example interface 400 need not be a geographic query, and can instead be a query relating to any topic of interest. In this example, the query is “football championship,” relating to a professional football championship game. The search system can retrieve news and social content results responsive to the query, e.g., news results 452 and 454 and social content results 462, 464, and 466.

For news and social content results responsive to the query, the search system can identify geographic entity names and plot the geographic entities in the viewport 430. In some implementations, the search system can use a database to identify a latitude and longitude location for a geographic entity name. Alternatively, the database can identify an address for a geographic entity name.

For example, in response to the query 410 “football championship,” the search system can retrieve news result 452, about a Chicago football team reaching the football championship game. The search system can identify geographic entity names in the news result, e.g., Chicago and Pittsburgh. Similarly, the search system can identify that news result 454 includes a geographic entity name “Glendale, Ariz.” In some implementations, the type of geographic entity identified depends on the zoom level of the user viewport 430. For example, because the user viewport 430 is at a zoom level that shows an entire country, the search system can identify only cities, states, or country geographic entities. At further zoomed-in levels, the search system could identify other geographic entities, such as business names or street names.

After identifying geographic entity names in the news or social content search results, the search system can identify a location for the geographic entity, e.g., by using a database of geographic entities. For each identified location, the search system can include a marker in the viewport 430 at the identified location. This process can provide the user with a view of activity in geographic locations relevant to the query 410.

For example, the search system includes a marker 422 at the geographic location for Chicago. For multiple markers, the system can cluster the markers to give the user an idea of the number of results identified for that geographic location. In some implementations, the size of the marker increases according to the number of news or social content results relevant to the query 410. In some other implementations, the color of the markers change according to the number of results relevant to the query 410, providing a “heat map” effect.

In a similar manner, the search system can identify geographic entities in social content results that were responsive to the query 410. For example, social content result 462 includes the geographic entity name “Pittsburgh.” The search system can identify the geographic location for Pittsburgh, Pa., and plot a marker in the user viewport accordingly. Social content result 464 includes the geographic entity name “Chicago,” and social content result 466 includes the geographic entity name “Glendale, Ariz.” The search system can include in the viewport 430 markers 424 and 426 for geographic locations corresponding to each of these geographic entities.

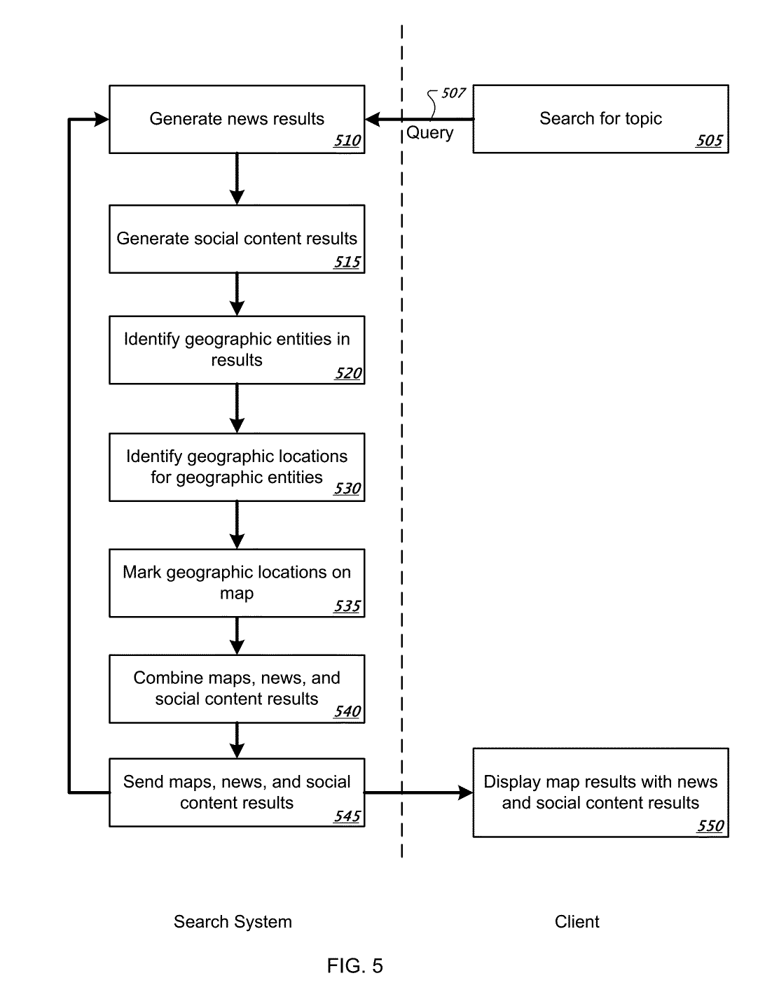

FIG. 5 is a flow chart of an example process to generate map results with aggregated news and social content results. In general, a search system obtains information news and social content results relevant to a query and identifies geographic entities in the results. For identified geographic entities, the search system identifies geographic locations and marks these geographic locations in the interactive mapping system. The search system can then combine the map results, news results, and social content results into an interface, e.g., the interface 400 as shown in FIG. 4.

A search for a topic is initiated (505). The search for a topic can be initiated by a user entering a query into a search box of an interface, e.g., the interface 400 as shown in FIG. 4. A query 507 is delivered to the search system. The query 507 can be identified as query for which map results and aggregated news and social content results should be retrieved, for example, when the user selects an interface to submit the query, or when the user includes a predefined keyword in the query.

The search system generates news results (510) and social content results (515). The results can be retrieved in a substantially similar manner to steps 320 and 325 as described with respect to FIG. 3. The search system need not retrieve results for both news and social content results, and can generate the results in any order or in parallel.

The search system identifies geographic entities in the results (520). In some implementations, the search system uses a database of geographic entity names to identify geographic entities in the news and social content results. The search system can also identify only certain types of geographic entities based on a current zoom level of a user viewport. For example, if the user viewport shows an entire country, the search system can only identify city, state, or country geographic entities.

The search system identifies geographic locations for the identified geographic entities (530). The search system can use a database to identify a latitude and longitude location or an address for each identified geographic entity.

The search system marks the identified geographic locations on a map (535). Using the identified geographic locations, the search system can include a marker in the viewport of an interactive mapping system. The search system can cluster the markers, use different sizes and shapes, or use color coding to indicate the number of markers at a common geographic location.

The search system combines the maps, news, and social content results (540). In some implementations, the search system combines the results into a single interface, e.g., the interface as shown in FIG. 4.

The search system sends the maps, news, and social content results to the client device (545). The search system can send these results over a communication network, e.g., the network 218 as shown in FIG. 2. The search system can also automatically and periodically update the news and social content search results (branch to 510). The search system can also accordingly update the corresponding location markers for geographic entities identified in newly retried news and social content results.

The client device displays the map results with the news and social content results (550).

This process provides the user with a continually and automatically updating “heat map” of geographic locations relevant to the provided query. In some implementations, the search system can allow the user to view a time lapse of previous news and social content results. The user can specify a previous time period and view an animation of geographic locations relevant to previous news and social content results, providing the user with a view of previous activity in geographic locations identified in previous news and social content search results.

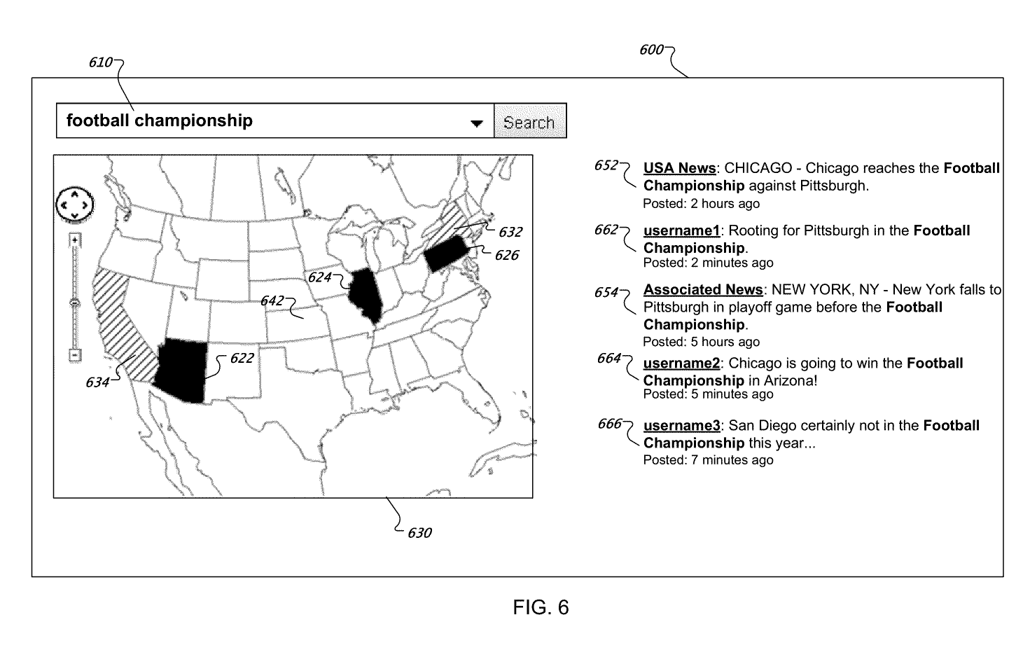

FIG. 6 is an illustration of an example interface 600 of a search system that provides an interactive mapping system with aggregated news and social content updates. The interface in FIG. 6 differentiates geographic regions based on the number of geographic locations in that region that were identified in news and social content search results. These geographic regions also provide a type of “heat map” that shows regions relevant to a particular submitted query.

The search system receives a query 610 and generates news and social content results, e.g., news results 652 and 654, and social content results 662, 664, and 666 responsive to the query. The search system identifies geographic entities in the news and social content results and their corresponding geographic locations by, e.g., using a database of geographic entities.

Instead of including a marker for each identified geographic location, the search system can maintain a count of the number of news and search results inside a geographic region. Any geographic region can be defined by the search system. However, in some implementations, using predefined geographic regions, e.g., states or countries, simplifies the process. For example, in interface 600, the geographic regions are states of the United States.

The search system can differentiate the presentation of the geographic regions according to the number of news and social content results identifying a location within that region. In some implementations, the geographic regions are differentiated by color. In some other implementations, the geographic regions are differentiated by fill pattern.

For example, geographic region 622 corresponds to Arizona. The search system can identify that social content result 664 includes the geographic entity “Arizona.” Other news and social content results that include “Arizona” as well as geographic entities within the state of Arizona can be counted. In response, the search system can present the geographic region of the viewport 630 corresponding to Arizona in a particular color, fill pattern, or other distinguishing characteristic.

The search system can identify that multiple news and social content results include “New York” or geographic entities contained within the state of New York. If the number of results responsive to the query 610 “football championship” that include “New York” (or geographic entities within New York) is different than the number of results that include “Arizona” (or geographic entities within Arizona), the search system can present the region 622 corresponding to New York with a different color, fill pattern, or other distinguishing characteristic.

In this example, geographic regions 622, 624, and 626 were most frequently identified as being included in news and social content results (e.g., news results 652 and 654, and social content results 662, 664, and 666) responsive to the query 610. In some implementations, the news and social content search results are grouped by their corresponding geographic region. The grouped geographic regions can be ranked by the frequency of news and social content search results in each respective geographic region. Geographic regions 632 and 634 had some, but fewer news and social content results that included these geographic regions (or geographic entities within these regions). The differentiation of geographic regions can be determined by multiple thresholds. For example geographic region 642 corresponding to Kansas is presented uncolored or without a fill pattern because fewer than a minimum number of news and social content results including “Kansas” were identified.

Thus, the interface 600 presents the user a quick “heat map” view of geographic regions included in news and social content search results responsive to a query 610 identifying a specific topic.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1-26. (canceled)

27. A method of providing an interactive map with both map results and dated news or social content updates responsive to a map query, the method comprising:
receiving, at a search system, a query from a user device, the query being expressed either as a text query or as a latitude and longitude query;
selecting, by a mapping engine of the search system, in response to receiving the query, map results responsive to the query, the map results defining map coordinates coinciding with a user viewport that displays the map results on the user device;
obtaining a text-form of the query;
selecting, by a search engine of the search system, in response to obtaining the text-form of the query, dated resources responsive to the text-form of the query, wherein the dated resources are news resources or social content resources;
ranking the responsive dated resources based at least on the date of each resource and the location of text corresponding to the text-form of the query within the respective dated resources; and
sending the user device the map results with the responsive dated resources to be presented according to the ranking.

28. The method of claim 27, wherein:
the query is a latitude and longitude query automatically generated by a user adjusting the viewport; and
the text-form of the query includes a name of a place in the adjusted viewport; and
the name of the place is obtained by:
querying, with the search system, a geographic information system for a set of places within the adjusted viewport; and
selecting, with the search system, a place from among the set of places within the adjusted viewport based on distances between a center of the map viewport and the respective places, wherein the entity name is the name of the selected place, and wherein zooming out tends to cause larger places to be selected and vice versa.

29. The method of claim 27, wherein:
the query is a text query; and
the text-form of the query is obtained by expanding or contracting the text query to a more popular form.

30. The method of claim 27, wherein:
the query is a text query including the name of a smaller geographic area and a name of a larger geographic area containing the smaller geographic area; and
the text-form of the query is obtained by truncating the name of the larger geographic area from the text query.

31. The method of claim 27, wherein:
the text form of the query includes a plurality of text queries, each corresponding to a different variation of a place name.

32. (canceled)

33. The method of claim 27, wherein selecting dated resources comprises:
determining that the user device is logged in to a user account in a social content service; and
selecting, in response to the user being logged in to the user account, social content that is associated with the user account and is unavailable to another user.

34. The method of claim 27, wherein selecting dated resources comprises:
determining that a given dated resource is social content from a contact of a user of the user device and selecting the given dated resource in response.

35. The method of claim 27, wherein:
the dated resources include both news and social content; and
ranking the responsive dated resources comprises ranking both the news and social content in a single ranking.

36. The method of claim 27, wherein:
the dated resources include resources of a first type and resources of a second type different from the first type;
ranking the responsive dated resources comprises:
ranking the resources of the first type, in a first ranking;
ranking the resources of the second type, in a second ranking, separate from the ranking of the resources of the first type; and
normalizing the first ranking and the second ranking such that neither type of resource tends to exclude the other type of resource from the presented dated resources.

37. The method of claim 27, wherein sending the user device the map results with the responsive dated resources to be presented according to the ranking comprises:
automatically updating the responsive dated resources; and
automatically presenting the updated responsive dated resources.

38. The method of claim 37, wherein automatically updating the responsive dated resources comprises:
periodically updating the responsive dated resources such that the user device presents an automatically updating stream of news and social content about a geographic area depicted in the viewport without a user having to enter a new query.

39. The method of claim 27, wherein:
the query is a latitude and longitude query automatically generated by a user adjusting the viewport; and
the latitude and longitude query is expressed as a latitude and longitude coordinate corresponding to the center of the viewport;
the text-form of the query includes a name of a place in the adjusted viewport; and
the name of the place is obtained by:
querying, by the search system, a geographic information system for a set of places within the adjusted viewport; and
selecting, by the search system, a place from among the set of places within the adjusted viewport based on a zoom level of the adjusted viewport such that zooming out tends to cause larger places to be selected and -zooming in tends to cause smaller places to be selected;
the dated resources include both news and social content, the social content being selected based on the social content being associated with a contact of a user of the user device;
the responsive dated resources are downranked based on age such that older responsive dated resources tend to have a lower ranking than fresher dated resources; and
dated resources that are news are upranked more based on the text-form of the query corresponding to a title of the respective resource than based on the text-form of the query corresponding to the body of the respective resource;
and wherein the method further comprises:
periodically updating the responsive dated resources such that the user device presents an automatically updating stream of news and social content about a geographic area depicted in the viewport without a user having to enter a new query.

40. A system, comprising:
one or more processors;
memory storing instructions that when executed by one or more of the processors cause the processors to effectuate operations comprising:
receiving, at a search system, a query from a user device, the query being expressed either as a text query or as a latitude and longitude query;
selecting, by a mapping engine of the search system, in response to receiving the query, map results responsive to the query, the map results defining map coordinates coinciding with a user viewport that displays the map results on the user device;
obtaining a text-form of the query;
selecting, by a search engine of the search system, in response to obtaining the text-form of the query, dated resources responsive to the text-form of the query, wherein the dated resources are news resources or social content resources;
ranking the responsive dated resources based at least on the date of each resource and the location of text corresponding to the text-form of the query within the respective dated resources; and
sending the user device the map results with the responsive dated resources to be presented according to the ranking.

41. A method comprising:
receiving a text query, the text query including one or more search terms provided by a user in a text input of an interactive map interface presented on a user device;
searching, with a computer, one or more collections of dated resources using the text query to obtain one or more resources responsive to the text query, wherein the dated resources are news resources or social content resources;
ranking the dated resources based at least on the date of each resource and the location of text corresponding to the text query within the respective dated resources;
generating a list of the one or more dated resources according to the rank for each resource;
identifying geographic entity names in the one or more obtained dated resources;
identifying a geographic regions corresponding to the identified geographic entity names;
generating map data based on the identified geographic regions; and
sending the map data with the list to the user device.

42. The method of claim 41, further comprising:
differentiating the identified geographic regions with location markers.

43. The method of claim 41, further comprising:
differentiating the identified geographic regions with different colors.

44. The method of claim 41, further comprising:
differentiating the identified geographic regions with different fill patterns.

45. The method of claim 41, wherein the identified geographic region corresponds to a region defined by a user viewport.

46. The method of claim 41, further comprising:
translating the text query into a second query before searching the one or more collections of dated resources, wherein translating the text query is performed before presenting the map data or receiving further input from the user.

47. The method of claim 41, further comprising:
automatically updating the ranked list of dated resources including searching updated additions to the one or more collections; and
providing the map data with the updated list.

48. The method of claim 47, wherein:
automatically updating the ranked list of dated resources including searching updated additions to the one or more collections comprises:
periodically updating the ranked list of dated resources; and
providing the map data with the updated list comprises:
providing an animated display differentiating geographic locations relevant to the text query, wherein the differentiation of the geographic regions changes through the course of the animated display.

49. The method of claim 41, wherein identifying geographic entity names in the one or more obtained dated resources comprises:
selecting among a hierarchy of types of geographic entities based on the zoom level of the user viewport, wherein the types include the type of cities and type of countries;
identifying names of geographic entities of the selected type.

50. A system, comprising:
one or more processors;
memory storing instructions that when executed by one or more of the processors cause the processors to effectuate operations comprising:
receiving a text query, the text query including one or more search terms provided by a user in a text input of an interactive map interface presented on a user device;
searching, with a computer, one or more collections of dated resources using the text query to obtain one or more resources responsive to the text query, wherein the dated resources are news resources or social content resources;
ranking the dated resources based at least on the date of each resource and the location of text corresponding to the text query within the respective dated resources;
generating a list of the one or more dated resources according to the rank for each resource;
identifying geographic entity names in the one or more obtained dated resources;
identifying a geographic regions corresponding to the identified geographic entity names;
generating map data based on the identified geographic regions; and
sending the map data with the list to the user device.
